(19) United States
(12) Patent Application Publication
(10) Pub. No.: US 2014/0107977 A1
(43) Pub. Date: Apr. 17, 2014

(54) CONDITION DIAGNOSING METHOD AND CONDITION DIAGNOSING DEVICE

(71) Applicant: MITSUBISHI AIRCRAFT CORPORATION, Aichi (JP)

(72) Inventors: Yasuo FUJISHIMA, Tokyo (JP); Keiichi KENMOTSU, Tokyo (JP); Mayumi SAITO, Tokyo (JP); Toshiya NAKAYAMA, Aichi (JP)

(73) Assignee: MITSUBISHI AIRCRAFT CORPORATION, Aichi (JP)

(21) Appl. No.: 14/052,067

(22) Filed: Oct. 11, 2013

(30) Foreign Application Priority Data
Oct. 16, 2012 (JP) 2012-228784

(51) Int. Cl. G06F 11/30

(52) U.S. Cl. CPC G06F 11/30
USPC 702/183

(57) ABSTRACT

A condition diagnosing method capable of executing condition diagnosis considering a secular change is provided. A condition diagnosing method includes a first diagnosing step of determining presence or absence of abnormality in diagnosis data by a latest one class support vector machine, and diagnosing the diagnosis data determined as abnormal as relating to a failure, and a second diagnosing step of determining presence or absence of abnormality in the diagnosis data determined as abnormal in the first diagnosing step by an initial one class support vector machine, diagnosing the diagnosis data determined as abnormal as relating to secular deterioration, and diagnosing the diagnosis data determined as not abnormal as normal.

### BACKGROUND

1. Technical Field

The present invention relates to a method of diagnosing whether a machine is operating in a normal state or not.

2. Related Art

For ensuring safety, necessity for condition diagnosis (abnormality detection and the like) of various kinds of machines such as airplanes has been increasing. The condition diagnosis techniques can be roughly divided into two techniques.

Technique 1: Preparing a mathematical model of a machine and estimating a condition (e.g., normal or abnormal).

Technique 2: Estimating a condition by pattern recognition such as machine learning.

When the diagnosis target is a complex system, it is difficult to construct a mathematical model that allows condition diagnosis with high accuracy. Further, when consideration is given even to characteristic changes of a target due to aging, it is difficult to apply the technique 1 to the complex system such as an airplane.

For the above background, the pattern recognition of the technique 2 may be applied to the condition diagnosis of the complex system. As an example, it has been attempted to apply, to the condition diagnosis, Support Vector Machines (SVMs) which are a kind of machine learning and have received attention for its high accuracy in recent years. Particularly, the One Class SVMs (One Class Support Vector Machines, B. Scholkopf, et al., “Estimating the Support of a High-Dimensional Distribution,” Neural Computation, vol. 13, no. 7, pp. 1443-471 July 2001.) capable of learning with only normal data have been actively applied in view of difficulty in data collection at the time of occurrence of abnormality (e.g., Japanese Patent Application Laid-open No. 2005-345154 A).

### SUMMARY

As already described, the machines are often affected by influences of characteristic changes due to aging. Additional learning that takes in the latest measurement data is required for executing condition diagnosis with high precision taking the secular changes into consideration. However, the Japanese Patent Application Laid-open No. 2005-345154 A gives no consideration to it.

Additionally, kernel methods which execute high-dimensional feature mapping while suppressing increase in computational complexity by defining only an inner product in a higher dimensional feature space are often used in combination with the SVMs. However, the diagnosis accuracy of the SVM changes to a large extent depending on the kernel used for it and kernel parameters thereof. Since “good” and “bad” of the kernel parameters depend on the data in hand, setting of the “good” kernel parameters is difficult in the additional learning in which the whole data is not prepared at the start of learning of the SVM.

Several proposals have been made for optimizing the kernel parameters (e.g., X. Yan, “Optimal Gaussian Kernel Parameter Selection for SVMClassifier,” IEICE Trans. Inf. & Syst., vol. E93-D, no. 12, pp. 3352-3358). However, all of those proposals are predicated on the multi-class sorting, and none of the proposals can be applied to the one class SVM. Also, execution of additional learning is not expected, and the existing technique in X. Yan, “Optimal Gaussian Kernel Parameter Selection for SVMClassifier,” IEICE Trans. Inf. & Syst., vol. E93-D, no. 12, pp. 3352-3358 is not suited for such a case.

The invention has been made based on the above technical problems, and a first object is to provide a condition diagnosing method which can distinguish the characteristic changes due to aging.

A second object of the invention is to provide a condition diagnosing method that can perform updating for optimizing the kernel parameters even with one class SVMs.

For achieving the first object, a condition diagnosing method of the invention includes the following configuration.

The condition diagnosing method of the present invention includes a first diagnosing step and a second diagnosing step.

The first diagnosing step determines presence or absence of abnormality in diagnosis data by a latest one class support vector machine, and diagnoses the diagnosis data determined as abnormal as relating to a failure.

The second diagnosing step determines presence or absence of abnormality in the diagnosis data determined as abnormal in the first diagnosing step by an initial one class support vector machine, diagnoses the diagnosis data determined as abnormal as relating to secular deterioration, and diagnoses the diagnosis data determined as not abnormal as normal.

In the present invention, the latest one class support vector machine is constructed by performing additional learning with the diagnosis data obtained from a diagnosis target at the time of the diagnosis, and the initial one class support vector machine is constructed by training with the data obtained when the diagnosis target was initially manufactured.

As described above, the present invention includes the two one class SVMs. In the first diagnosing step executed first can distinguish data corresponding to abnormality, that is, failure from the other data. However, it is impossible to distinguish the data containing characteristic changes due to aging and contained in the other data. Accordingly, the present invention further applies the initial one class support vector machine, and thereby the invention can diagnose the data containing the characteristic changes due to aging as abnormal, and can diagnose the other data as normal.

Apparently, by employing the two one class SVMs, the distinction between the diagnosis results can be performed substantially in the same manner even when a change occurs in sequence of the determination of presence and absence of the abnormality by the latest one class support vector machine and the determination of presence and absence of the abnormality by the initial one class support vector machine.

Thus, the present invention provides a condition diagnosing method including the following third and fourth diagnosing steps.

The third diagnosing step determines presence or absence of abnormality in diagnosis data by an initial one class support vector machine, and diagnoses the diagnosis data determined as not abnormal as normal.

The fourth diagnosing step determines presence or absence of abnormality in the diagnosis data determined as abnormal in the third diagnosing step by a latest one class support vector machine, diagnoses the diagnosis data determined as abnormal as relating to a failure, and diagnoses the diagnosis data determined as not abnormal as relating to the secular deterioration.

The initial one class support vector machine and the latest one class support vector machine are the same as those already described.

For achieving the second object, the present invention is configured such that, in the additional learning, a distance between the added diagnosis data and a previous normal region is handled as an evaluation function, and a kernel parameter σ of the latest one class support vector machine is updated.

Conventionally, when only one class of training data is present, a counterpart for defining a distance is not present so that an evaluation function cannot be introduced.

The invention handles the added diagnosis data as an object for defining a distance to the previous normal region, and thereby can introduce the evaluation function. Therefore, the invention can update and optimize the kernel parameter σ even with the one class SVM.

When the invention is configured to perform the additional learning when new diagnosis data is to be diagnosed, a normal region determined by a preceding additional learning is handled as a previous normal region.

Preferably, in the additional learning of the invention, the kernel parameter σ is not updated when a maximum value of a result of arithmetic of the evaluation function with the added diagnosis data is equal to or lower than a predetermined threshold.

This is for avoiding the kernel parameter σ from reducing more than necessary.

The additional learning of the invention handles the diagnosis data not included in the previous normal region as targets of the additional learning for reducing a training time, and the diagnosis data included in the previous normal region is preferably excluded from the targets of the additional learning.

In the invention, the one class SVM is preferably constructed by applying the kernel specified in the formula (8) shown below. This can improve the diagnosis accuracy for a specific abnormal detection. The kernel of the formula (8) may be applied to one or both of the latest one class support vector machine and the initial one class support vector machine.

$$\begin{matrix}[ Math . 1 ] & \\ κ ( x , z ) = exp ( - \frac{{\vert {x}_{m} - {z}_{m} \vert}^{2}}{{σ}_{2}^{2}} ) exp ( - \frac{{‖ x - z ‖}^{2}}{{σ}^{2}} ) & formula ( 8 )\end{matrix}$$

The invention enables the condition diagnosis with consideration given to the changes in machine due to aging.

Also, the invention can update and optimize the kernel parameter σ even in one class SVMs.

### BRIEF DESCRIPTION OF DRAWINGS

FIG. 1 is a block diagram illustrating a structure of a condition diagnosis system in embodiments;

FIG. 2A illustrates a process flow of the condition diagnosis system of a first embodiment, and FIG. 2B illustrates a process flow of a conventional condition diagnosis system;

FIG. 3 illustrates an example (x is two-dimensional) of results of condition diagnosis using a one class SVM (Gaussian kernel);

FIG. 4 illustrates an image of a failed portion diagnosis by an SOM (Self Organizing Map);

FIG. 5 illustrates a process flow of a diagnosis system of a second embodiment;

FIG. 6 illustrates a distance meant by an evaluation function J;

FIG. 7 illustrates a process flow of a kernel parameter sequential optimization method in the second embodiment;

FIG. 8A illustrates an example of results obtained by application of a manner in FIG. 6 (good modeling of normal data distribution), FIG. 8B illustrates an example of the case of an excessively small kernel parameter σ (overfitting), and FIG. 8C illustrates an example of the case of an excessively large kernel parameter σ (low diagnosis ability); and

FIG. 9 illustrates another example of a process flow of a condition diagnosis system in the embodiments.

### DETAILED DESCRIPTION

### First Embodiment

The invention will be described in details with reference to embodiments illustrated in attached drawings.

A condition diagnosis system 1 of an embodiment aims at diagnosis of failure signs of diagnosis targets such as machines, devices or the like.

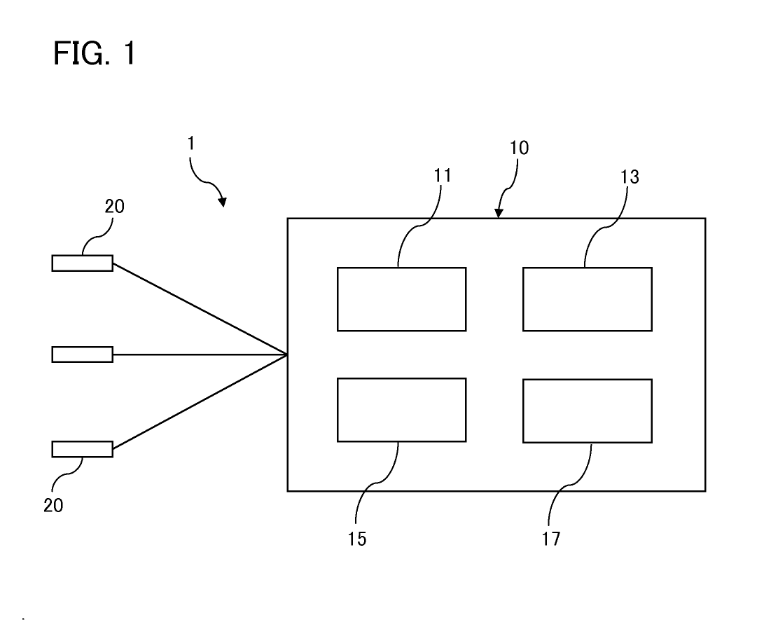

The condition diagnosis system 1 has, as illustrated in FIG. 1, a device body 10 including a controller 11, a storage 13, an input 15 and a display 17 as well as a detection sensor 20. The detection sensor 20 is attached to a diagnosis target (not illustrated), and obtains necessary measurement data (diagnosis data). Based on the diagnosis data obtained by the detection sensor 20, the device body 10 executes construction of a one class SVM described later and condition diagnosis by the constructed one class SVM. An example of diagnosing failure signs of the diagnosis target is described in this description. However, it is obvious that the invention may be used for other kinds of condition diagnosis.

The controller 11 is formed of a CPU (Central Processing Unit) and memories such as a ROM (Read Only Memory) and a RAM (Random Access Memory).

The CPU reads a program (software) stored in the storage 13 and/or the memory into a specific area, and implements processing for the condition diagnosis to be described later according to the program.

The storage 13 is formed of, for example, an HDD (Hard Disc Drive) or an SDD (Solid State Drive), and stores programs to be executed by the controller 11 as well as data and an OS (Operating System) required for executing the program.

The input 15 is formed of, for example, known input devices such as a keyboard and a mouse. Manipulation and operation instructions as well as data input and the like can be performed on the condition diagnosis system 1 through the input 15.

The display 17 is formed of an LCD (Liquid Crystal Display) or the like, and displays the diagnosis results of the condition diagnosis system 1 and others.

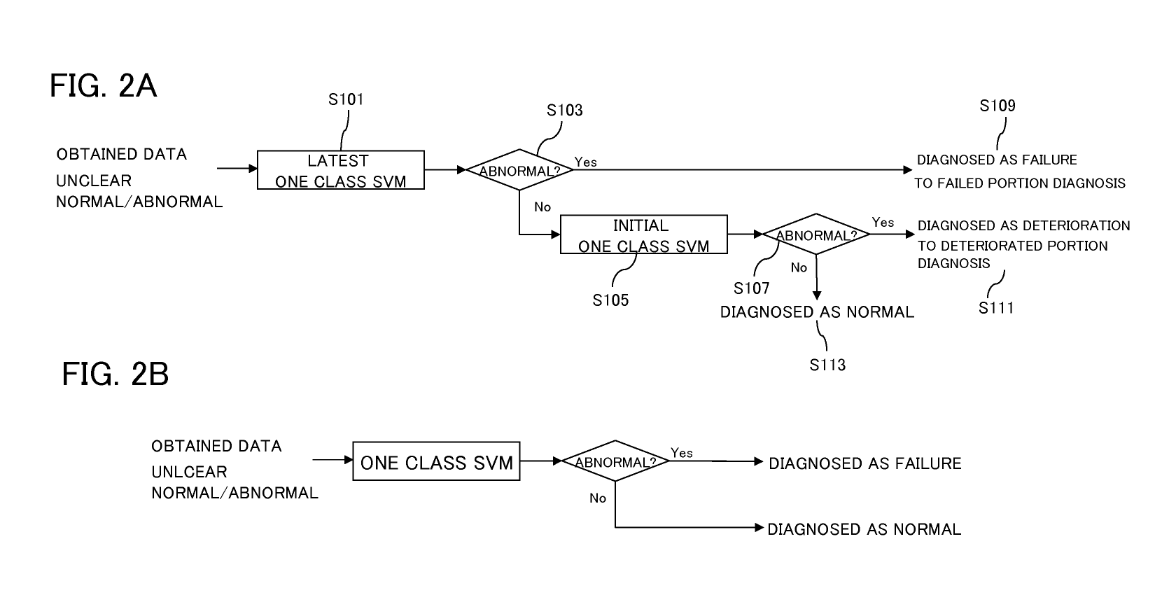

The condition diagnosis system 1 performs the condition diagnosis according to the process flow illustrated in FIG. 2A, and has such a feature that the two one class SVMs, that is, the latest one class SVM and the initial one class SVM are prepared to execute successively the condition diagnosis. These two one class SVMs are predicated on introduction of the kernel method. Although the kernel method itself is well known among those skilled in the art, the one class SVM employing the kernel method will be described first in brief.

In the one class SVM employing the kernel method, an optimum α is found in connection with an evaluation function (formula (1)),

$$\begin{matrix}[ Math . 2 ] & \\ {min}_{α} \frac{1}{2} {\sum }_{i , j} {α}_{i} {α}_{j} κ ( {x}_{i} , {x}_{j} ) \\ subject to 0 \leq {α}_{i} \leq \frac{1}{vl} , \\ {\sum }_{i = 1}^{l} {α}_{i} = 1 & formula ( 1 )\end{matrix}$$

In the above, xᵢ (i=1, 2, . . . , and l) and xⱼ (j=1, 2, . . . , and l) are training data, and training of finding optimum α is performed by applying these data items. The number l is the number of training data items. The letter ν is an upper limit value (between 0 and l inclusive) of a rate at which the training data is regarded as an outlier, and the normal region does not contain the training data regarded as the outlier. In the description, since it is assumed that the one class SVM is applied to the condition diagnosis such as abnormality detection, all the training data is the data in the normal operation. The one class SVM receives such normal data and is trained so that it can recognize the pattern (normal region) of the normal data. Further, a letter κ is referred to as “kernel”, and represents arithmetic of an inner product in a feature space. Thus, kernel κ is specified by the following formula (2), and calculates the inner product by mapping given data (x, z) to the feature space (feature mapping φ), but the kernel is directly defined without defining the feature mapping φ. A letter φ is defined implicitly by defining the kernel κ. This can significantly reduce the times required for selecting and executing the feature mapping. The one class SVM uses, as the kernel, the following formula (3) called as a “Gaussian kernel” in nearly every case, and the invention is likewise predicated on use of the Gaussian kernel. The use of the Gaussian kernel implicitly defines the infinite-dimensional feature mapping φ, and allows processing in the infinite dimensional feature space with a small calculation amount. Here, a letter σ is referred to as a “kernel parameter”, and is a very important element which significantly affects the identification accuracy. In many cases, operations by trial and error determine σ.

$$\begin{matrix}[ Math . 3 ] & \\ κ ( x , z ) = 〈 φ ( x ) , φ ( z ) 〉 & formula ( 2 ) \\ [ Math . 4 ] & \\ κ ( x , z ) = exp ( - \frac{{‖ x - z ‖}^{2}}{{σ}^{2}} ) & formula ( 3 )\end{matrix}$$

In the one class SVM, a discriminant expressed by the formula (4) executes (tests) clustering of data x (test data) of unknown classes. Here, a sgn(•) is a sign function. Return of +1 represents such diagnosis by the one class SVM that the input (diagnosis) data x belongs to the same class as the training data. Conversely, return of −1 represents such diagnosis that x belongs to a class other than that of the training data. As described above, in the abnormality detection, when the +1 is returned, the data is diagnosed as normal at the time of obtaining the data x. In the case of −1, the data is diagnosed as abnormal.

$$\begin{matrix}[ Math . 5 ] & \\ f ( x ) = sgn ( {\sum }_{i} {α}_{i} κ ( {x}_{i} , x ) - ρ ) & formula ( 4 )\end{matrix}$$

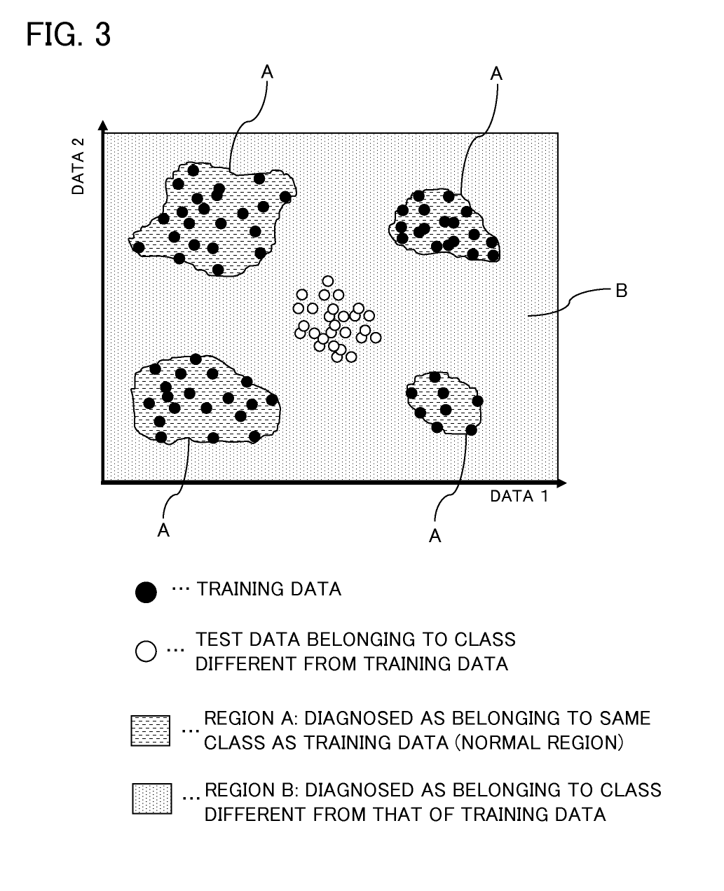

FIG. 3 illustrates an example of a result of the condition diagnosis performed with the one class SVM (Gaussian kernel). This example relates to the case where x is two-dimensional.

As illustrated in FIG. 3, the one class SVM employing the kernel method has such a feature that a region (normal region) A used in the condition diagnosis can have a complicated shape when the training data (solid circle) is obtained. A region B except for the region A is used for diagnosing as belonging to a class different from that of the training data. Thus, by performing the training, a discriminator of one class SVM provided with the regions A and B is constructed in advance. The “latest one class SVM” and the “initial one class SVM” in FIG. 2A represent such discriminators. For diagnosing the diagnosis target, the discriminant expressed by the formula (4) diagnoses whether the obtained data (diagnosis data) belongs to the region A (normal) or the region (B) (abnormal).

Further, the embodiment includes two one class SVM discriminators (FIG. 2A).

One of them is the initial one class SVM. The initial one class SVM is constructed by training with data (training data) that was obtained when a machine system forming a diagnosis target starts an operation. It is impossible to discriminate only by the initial one class SVM between the abnormality due to a failure or the abnormality due to a secular change.

Accordingly, the embodiment also includes the latest one class SVM. The latest one class SVM performs the additional learning by taking the latest data into the previous one class SVM during the operation of the diagnosis target. This latest data functions as the training data for constructing the one class SVM, and also functions as the diagnosis data. The data vectors thus taken are in time series measured by the detection sensor 20.

For example, the initial one class SVM is applied as the latest one class SVM before the initial additional learning, and the additional learning is successively performed so that the latest one class SVM is constructed.

By introducing the evaluation function, this latest one class SVM can successively optimize the kernel parameter in response to every capturing of the latest data, and the preferred manner thereof will be described in connection with a second embodiment.

The condition diagnosis system 1 provided with the two one class SVMs performs the condition diagnosis in the order illustrated in FIG. 2A.

First, the latest one class SVM diagnoses the diagnosis data obtained by the detection sensor 20 for the diagnosis (S101, S103). When the result of the diagnosis is abnormal (Yes in S103), this data is determined as failure (S109). Since this determination reflects the additional learning into which the latest data is taken, it reflects the current condition of the machine system. The data determined as failure then undergoes the diagnosis for a failed portion. The diagnosis for the failed portion will be described later.

The data (No in S103) which is not determined as abnormal by the latest one class SVM is then determined by the initial one class SVM whether it is abnormal or not (S105, S107). Since the data relating to a failure is already removed from the data to be determined by the initial one class SVM, it is diagnosed that the secular deterioration has occurred in the data determined as abnormal (Yes in S107, S111). The data determined as deterioration then undergoes diagnosis for the deteriorated portion. The diagnosis for the deteriorated portion will be described later.

The data diagnosed as not abnormal by the initial one class SVM is diagnosed that the diagnosis target is operating normally (No in S107, S113).

When the one class SVM is only one in number as illustrated in FIG. 2B, in contrast to the embodiment, the diagnosis is performed for discrimination between failure and normal, but either the failure or the normal contains the characteristic changes due to the aging.

The condition diagnosis system 1 is configured to perform diagnosis about the normal, deterioration and abnormal, and further estimates the failed or deteriorated portion as already described. As described below, Self Organizing Map (SOM, T. Kohonen, “Self-Organized Formation of Topologically Correct Feature Maps,” Biological Cybernetics, vol. 43, pp. 59-69, 1982) is applied to estimation of the failed or deteriorated portion.

The SOM is a kind of multi-clustering technique (a technique of classifying multiple kinds of data according to the kind), and maps multi-dimensional data to a low-dimensional space such as a two-dimensional space. In this processing, similar items of data are arranged close to each other on the low-dimensional space (plane when it is two-dimensional), and thereby executes multi-clustering. Therefore, results of clustering of the multi-dimensional data can be visually captured.

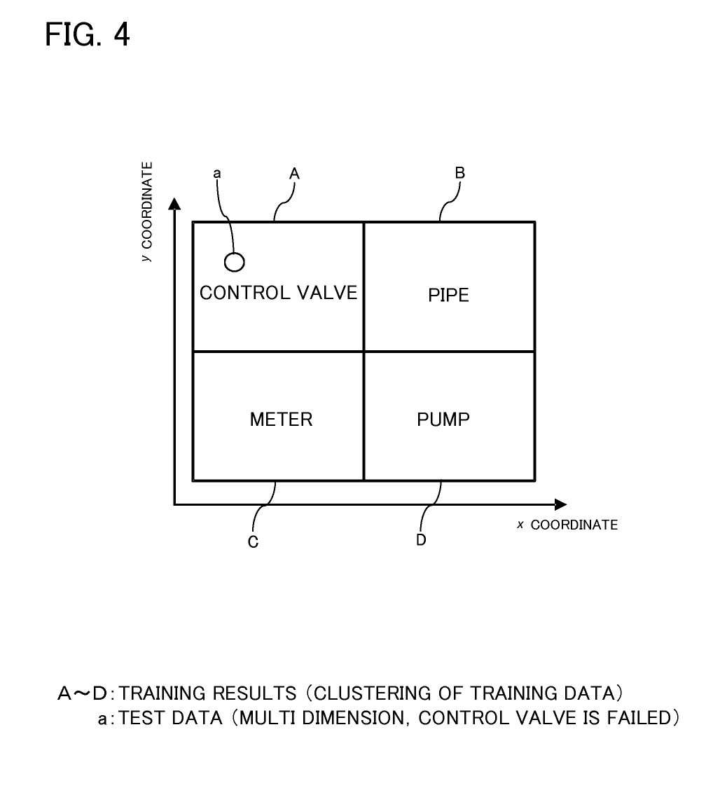

In the SOM, it is assumed that data behaves in different manners corresponding to respective failed (or deteriorated) portions, and the data is classified according to the failed portion by providing a plurality of abnormal data items of different failed portions to the SOM. FIG. 4 illustrates an image of portion diagnosis by the SOM using different kinds of failure data items.

The example in FIG. 4 relates to four portions, that is, a control valve, a pipe, a meter and a pump, and illustrates training results A-D (clustering of the training data) and test data a of the four portions. The test data a in this example is obtained when the control valve failed, and is mapped into a group (A) formed when the control valve failed.

In the training, a map for clustering is prepared by using a sample of various kinds of data. When the data is gathered corresponding to the respective kinds (when the groups are formed), it is deemed that the training is successful. For the failed portion diagnosis, the training of the SOM is executed using the sample of multiple kinds of failure data, and it is successful when the data groups are formed corresponding to the respective failed portions. In the test, data items of unknown kinds are applied, and a relation between the items and the mapping coordinates corresponding to the kinds thereof is inspected. When the mapping to groups of the kinds to which the data items belong is performed, it is correct.

As described above, the condition diagnosis system 1 according to the first embodiment performs the additional learning in the latest one class SVM so that the latest characteristics of the diagnosis target can always be reflected in the diagnosis result. Since the condition diagnosis system 1 has the latest one class SVM and the initial one class SVM, it can discriminate between the failure and the deterioration.

### Second Embodiment

In the additional learning of the latest one class SVM employed in the first embodiment, the kernel parameter is successively optimized by a specific achieving manner which will be described below as a second embodiment.

According to the substance, introduction of the evaluation function can successively optimize the kernel parameter (here, primarily, Gaussian kernel). Further, the optimization can be performed while performing the additional learning, and the embodiment can be applied to the one class SVM that is not a multi-class classification.

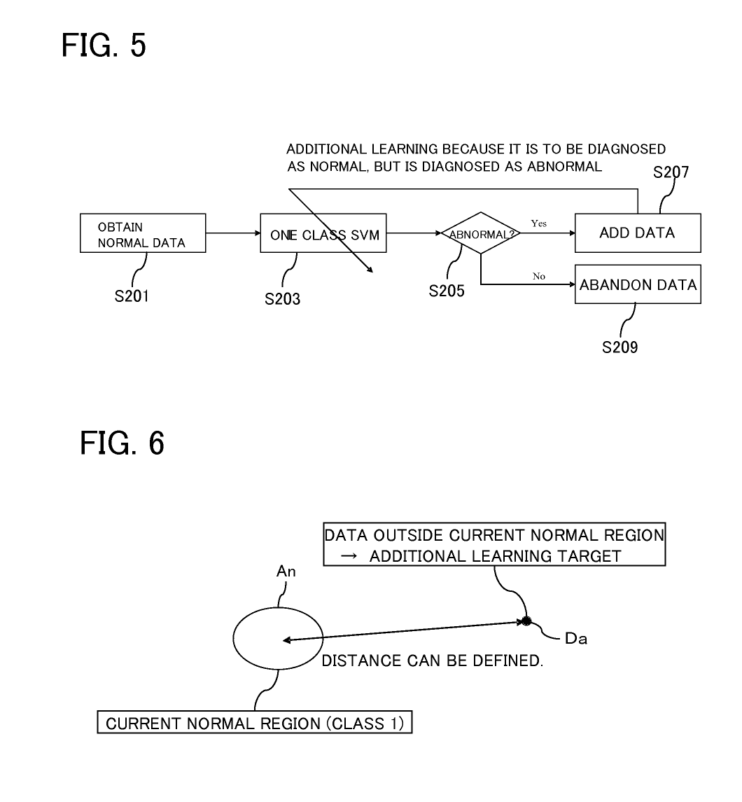

In the second embodiment, the additional learning employs the technique disclosed in K. Ikeda and T. Yamasaki, “Incremental Support Vector Machines and Their Geometrical Analysis,” Neurocomputing, vol. 70, pp. 2528-2533, August 2007. When this technique is applied to the one class SVM for the failure diagnosis, the processing flows as illustrated in FIG. 5. If the additional learning of all the normal data were performed, an extremely long time would be required for training the SVM. Therefore, this embodiment is essentially configured to abandon unnecessary data without using it for the training. Thus, the one class SVM performs the diagnosis on the obtained data (S201 in FIG. 5) to determine whether it is abnormal or not (S203, S205 in FIG. 5). Since this processing relates to the training, all the obtained data is to be diagnosed as normal. Therefore, the data diagnosed as abnormal by the diagnosis is handled as a target of the additional learning, and is added to the one class SVM (Yes in S205, S207 in FIG. 5). Conversely, even if the data diagnosed as normal were added, this would merely spend a training time. Therefore, such data is abandoned (No in S205, S209 in FIG. 5). This reduces the training time. Criteria for the determination as abnormal is the same as the criteria of the normal/abnormal determination of the previous one class SVM that was trained with the data obtained at or before that point in time.

When the data x is to be added in the additional learning already described, the kernel parameter is successively optimized by introducing the evaluation function J specified by the formula (5). With respect to the previous normal region (class 1) An, a distance to additional data Da located outside the region An can be defined. Thus, the evaluation function J means a distance between additional data Da in the specific space and the normal region An at that point in time as illustrated in FIG. 6. For defining this distance, an average position (a center of gravity) in the normal region An can be handled as a criterion.

As described above, even the one class SVM can define the distance by handling the normal data outside the previous normal region as an endpoint.

$$\begin{matrix}[ Math . 6 ] & \\ \begin{matrix}J ( σ ) = {‖ φ ( x ) - μ ‖}^{2} \\ = {‖ φ ( x ) ‖}^{2} - 2 {μ}^{T} φ ( x ) + {μ}^{T} μ \\ = κ ( x , x ) = \frac{2}{l} {\sum }_{i = 1}^{l} κ ( x , {x}_{i} ) + \frac{1}{l 2} {\sum }_{i = 1}^{l} {\sum }_{j = 1}^{l} κ ( {x}_{i} , {x}_{j} )\end{matrix} & formula ( 5 )\end{matrix}$$

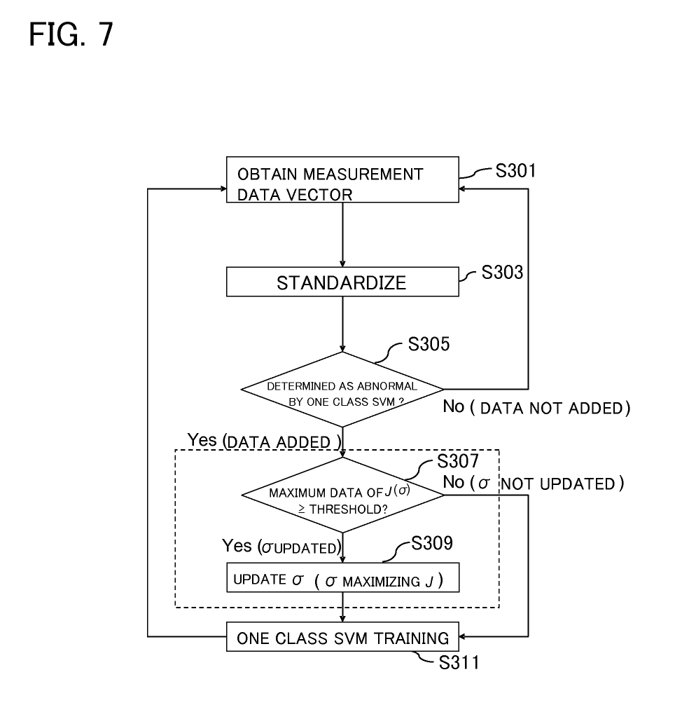

Specific procedures of successively optimizing the kernel parameter are illustrated in FIG. 7.

First, a measurement data vector is obtained and standardized (S301, S303 in FIG. 7). All the obtained data is to be diagnosed as normal, as already described. The obtained data is standardized by setting the average and the dispersion to 0 and 1, respectively, for unifying the scale.

Then, the one class SVM determines whether the standardized data is abnormal or not (S305 in FIG. 7). This determination procedure is already described with reference to FIG. 5. When it is determined as abnormal (Yes in S305, FIG. 7), this data is added to the one class SVM as the target of the additional learning. When it is not determined as abnormal (No in S305, FIG. 7), the data is abandoned.

In this embodiment, when the maximum value of J(σ) defined in the formula (5) for the successive optimization is smaller than a predetermined threshold, the kernel parameter σ is not updated for avoiding unnecessary reduction of the kernel parameter σ (No in S307, FIG. 7). When the maximum value of J(σ) is equal to or larger than the predetermined threshold, the kernel parameter σ is updated (Yes in S307, S309, FIG. 7), and new training of the one class SVM is performed (S311 in FIG. 7).

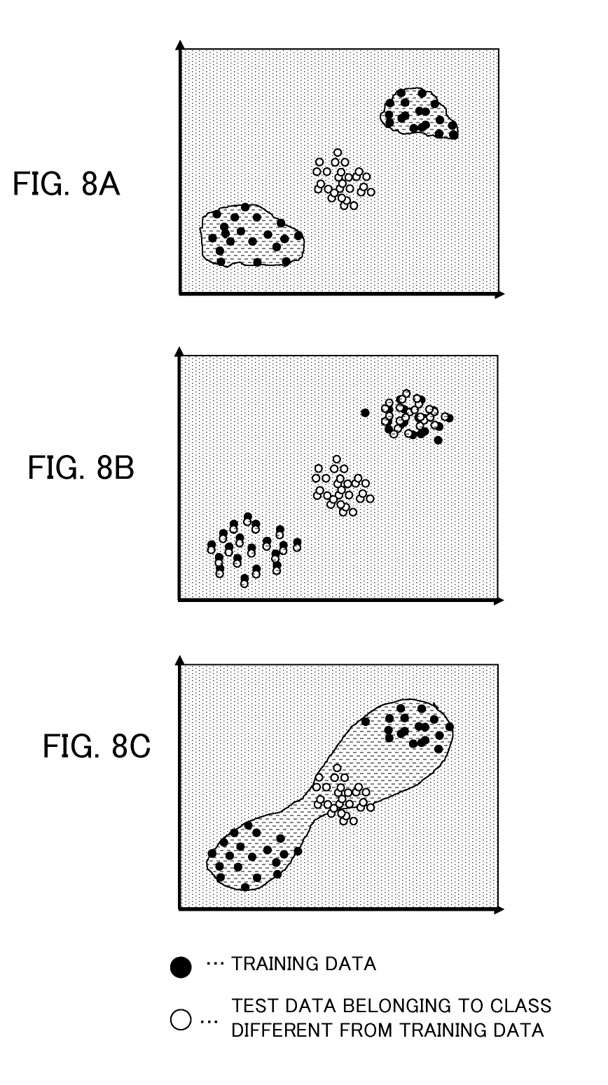

FIG. 8A illustrates an image of the one class SVM that is newly configured according to the above procedures. FIG. 8A illustrates that the application of the appropriate kernel parameter σ sets the normal region of an appropriate range with respect to the training data (normal data).

Conversely, FIGS. 8B and 8C illustrate the cases where the kernel parameter σ is excessively small and excessively large, respectively. When the kernel parameter σ is excessively small, the normal region is excessively narrow so that data not matching with the training data may be determined as abnormal. Conversely, when the kernel parameter σ is excessively large, the normal region is excessively large so that the data to be determined as abnormal may be determined as normal.

As described above, the second embodiment can successively optimize the kernel parameter (primarily, Gaussian kernel) by introducing the evaluation function. Further, the optimization can be performed while performing the additional learning, and the embodiment can be applied to the one class SVM that is not a multi-class classification.

Since the kernel parameter can be determined systematically as described above, it is possible to reduce the time required for try and error in the algorithm design.

### Third Embodiment

A third embodiment will be described in connection with a new kernel improved for increasing the diagnosis accuracy.

This new kernel is expressed by a formula (6), and introduction thereof increases a sensitivity with respect to specific abnormal events as compared with a conventional Gaussian kernel. In the formula (6), σ₂ represents a new parameter.

$$\begin{matrix}[ Math . 7 ] & \\ κ ( x , z ) = exp ( - \frac{{\vert {x}_{1} - {z}_{1} \vert}^{2}}{{σ}_{2}^{2}} ) exp ( - \frac{{‖ x - z ‖}^{2}}{{σ}^{2}} ) & formula ( 6 )\end{matrix}$$

The new kernel increases a sensitivity to a first measurement item x₁ in a measurement vector x=[x₁, x₂, . . . x_{M}]. The first is merely an example, and can be generally handled as m-th. The letter M is the number of items used for the abnormality detection.

The new kernel is based on a conventional Gaussian kernel, and the Gaussian kernel is deemed as calculating a similarity between the two data items x and z. By introducing the new kernel of multiplying the above kernel by a coefficient specified by the formula (7), a difference between x₁ and z₁ is further emphasized to improve the diagnosis accuracy.

$$\begin{matrix}[ Math . 8 ] & \\ exp ( - \frac{{\vert {x}_{1} - {z}_{1} \vert}^{2}}{{σ}_{2}^{2}} ) & formula ( 7 )\end{matrix}$$

Employment of this embodiment achieves the following effects. For example, when such prior knowledge is already obtained that a slight difference is present in data x₁ between the normal state and the abnormal state, and the slight difference is important, the use of the kernel proposed herein further facilitates detection of the abnormal phenomenon. In other words, the reflection of the prior knowledge to the kernel can improve the diagnosis accuracy with respect to the specific abnormality detection.

The improved kernel thus proposed can be applied to both the first and second embodiments.

Although the embodiments of the invention have been described, the structures employed in the embodiments may be selected only partially, and may be appropriately changed into other structures unless they depart from the spirit and scope of the invention.

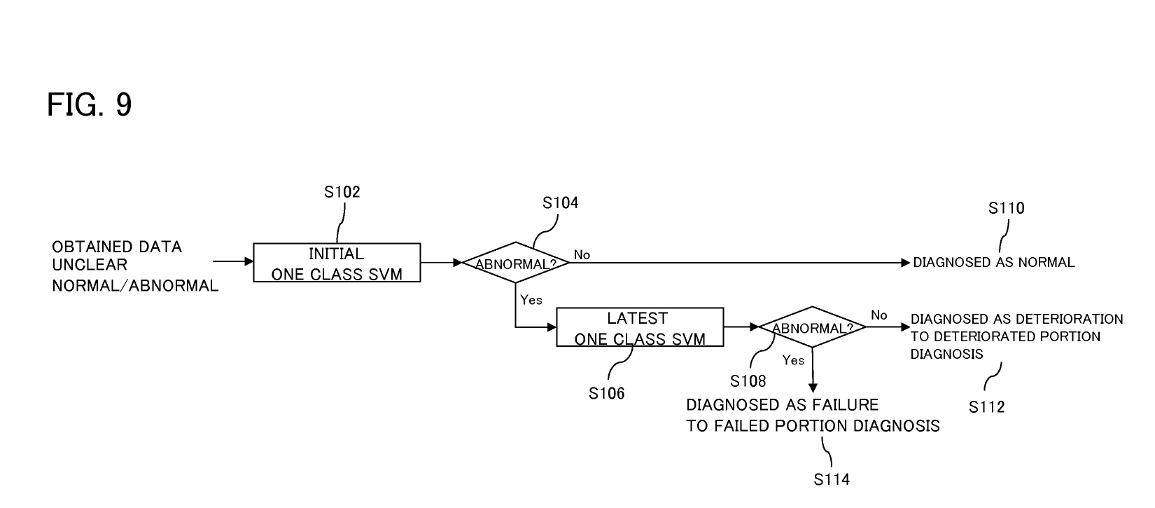

The condition diagnosis system 1 has been described as it performs the condition diagnosis by the procedures illustrated in FIG. 2A, but it may perform the condition diagnosis by procedures illustrated in FIG. 9.

The initial one class SVM first diagnoses diagnosis data obtained by a detection sensor 20 for the diagnosis (S102, S104 in FIG. 9). When the data is not determined as abnormal by the diagnosis (No in S104, FIG. 9), the diagnosis target is diagnosed as operating normally (S110).

For the data diagnosed as abnormal, the latest one class SVM performs discrimination between abnormal or not (S106, S108 in FIG. 9). The data not determined as abnormal is diagnosed as the secularly deteriorated data (No in S108 and S112 in FIG. 9). The data determined as abnormal is diagnosed as failure (Yes in S108, S114 in FIG. 9).

What is claimed is:

1. A condition diagnosing method comprising:
a first diagnosing step of determining presence or absence of abnormality in diagnosis data by a latest one class support vector machine, and diagnosing the diagnosis data determined as abnormal as relating to a failure; and
a second diagnosing step of determining presence or absence of abnormality in the diagnosis data determined as abnormal in the first diagnosing step by an initial one class support vector machine, diagnosing the diagnosis data determined as abnormal as relating to secular deterioration, and diagnosing the diagnosis data determined as not abnormal as normal, wherein
the latest one class support vector machine is constructed by performing additional learning with the diagnosis data obtained from a diagnosis target at the time of the diagnosis, and
the initial one class support vector machine is constructed by training with the data obtained when the diagnosis target was initially manufactured.

2. A condition diagnosing method comprising:
a third diagnosing step of determining presence or absence of abnormality in diagnosis data by an initial one class support vector machine, and diagnosing the diagnosis data determined as not abnormal as normal; and
a fourth diagnosing step of determining presence or absence of abnormality in the diagnosis data determined as abnormal in the third diagnosing step by a latest one class support vector machine, diagnosing the diagnosis data determined as abnormal as relating to a failure, and diagnosing the diagnosis data determined as not abnormal as relating to secular deterioration, wherein
the latest one class support vector machine is constructed by performing additional learning with the diagnosis data obtained from a diagnosis target at the time of the diagnosis, and
the initial one class support vector machine is constructed by training with the data obtained when the diagnosis target was initially manufactured.

3. The condition diagnosing method according to claim 1, wherein
in the additional learning, a distance between the added diagnosis data and a previous normal region is handled as an evaluation function, and a kernel parameter σ of the latest one class support vector machine is updated.

4. The condition diagnosing method according to claim 2, wherein
in the additional learning, a distance between the added diagnosis data and a previous normal region is handled as an evaluation function, and a kernel parameter σ of the latest one class support vector machine is updated.

5. The condition diagnosing method according to claim 3, wherein
the kernel parameter σ is not updated when a maximum value of a result of arithmetic of the evaluation function with the added diagnosis data is equal to or lower than a predetermined threshold.

6. The condition diagnosing method according to claim 4, wherein
the kernel parameter σ is not updated when a maximum value of a result of arithmetic of the evaluation function with the added diagnosis data is equal to or lower than a predetermined threshold.

7. The condition diagnosing method according to claim 3, wherein
the additional learning handles the diagnosis data not included in the previous normal region as targets of the additional learning, and
excludes the diagnosis data included in the previous normal region from the targets of the additional learning.

8. The condition diagnosing method according to claim 4, wherein
the additional learning handles the diagnosis data not included in the previous normal region as targets of the additional learning, and
excludes the diagnosis data included in the previous normal region from the targets of the additional learning.

9. The condition diagnosing method according to claim 1, wherein
one or both of the latest one class support vector machine and the initial one class support vector machine is constructed by applying the kernel specified in the following formula (8), provided that m is 1, 2, 3, . . . M.
$$\begin{matrix}[ Math 1 ] & \\ κ ( x , z ) = exp ( - \frac{{\vert {x}_{1} - {z}_{1} \vert}^{2}}{{σ}_{2}^{2}} ) exp ( - \frac{{‖ x - z ‖}^{2}}{{σ}^{2}} ) & formula ( 8 )\end{matrix}$$

10. The condition diagnosing method according to claim 2, wherein
one or both of the latest one class support vector machine and the initial one class support vector machine is constructed by applying the kernel specified in the following formula (8), provided that m is 1, 2, 3, . . . M.
$$\begin{matrix}[ Math 1 ] & \\ κ ( x , z ) = exp ( - \frac{{\vert {x}_{1} - {z}_{1} \vert}^{2}}{{σ}_{2}^{2}} ) exp ( - \frac{{‖ x - z ‖}^{2}}{{σ}^{2}} ) & formula ( 8 )\end{matrix}$$

11. A condition diagnosing device comprising:
a first diagnosing unit determining presence or absence of abnormality in diagnosis data by a latest one class support vector machine, and diagnosing the diagnosis data determined as abnormal as relating to a failure; and
a second diagnosing unit of determining presence or absence of abnormality in the diagnosis data determined as abnormal by the first diagnosing unit by an initial one class support vector machine, diagnosing the diagnosis data determined as abnormal as relating to secular deterioration, and diagnosing the diagnosis data determined as not abnormal as normal, wherein
the latest one class support vector machine is constructed by performing additional learning with the diagnosis data obtained from a diagnosis target at the time of the diagnosis, and
the initial one class support vector machine is constructed by training with the data obtained when the diagnosis target was initially manufactured.

12. A condition diagnosing method comprising:
a third diagnosing unit of determining presence or absence of abnormality in diagnosis data by an initial one class support vector machine, and diagnosing the diagnosis data determined as not abnormal as normal; and
a fourth diagnosing unit of determining presence or absence of abnormality in the diagnosis data determined as abnormal by the third diagnosing unit by a latest one class support vector machine, diagnosing the diagnosis data determined as abnormal as relating to a failure, and diagnosing the diagnosis data determined as not abnormal as relating to secular deterioration, wherein
the latest one class support vector machine is constructed by performing additional learning with the diagnosis data obtained from a diagnosis target at the time of the diagnosis, and
the initial one class support vector machine is constructed by training with the data obtained when the diagnosis target was initially manufactured.
